(19) United States
(12) Patent Application Publication
(10) Pub. No.: US 2015/0348196 A1
(43) Pub. Date: Dec. 3, 2015

(54) System and method for financial forecasting and report generation

(71) Applicant: Josh Stampfli, Scarsdale, NY (US)

(72) Inventor: Josh Stampfli, Scarsdale, NY (US)

(21) Appl. No.: 14/289,693

(22) Filed: May 29, 2014

(51) Int. Cl. G06Q 40/06

(52) U.S. Cl. CPC G06Q 40/06

(57) ABSTRACT

A system and method for financial forecasting and report generation provides a computerized system for providing forecasts of possible future financial outcomes and generating a report to explain the results of the forecasts. The system receives and stores information related to the forecast, generates a series of possible future financial outcomes, and provides a customizable framework for displaying obtained results and generating reports depicting the obtained results.

The present invention is a significant improvement over prior art in forecasting in that it allows the user to select from a range of possible asset return models, it allows the user to specify a range of inflow and outflow formulae which may themselves incorporate time varying parameters or be dependent on other variables within the model, it allows the user to select from an array of portfolio balancing and risk management techniques and to therefore incorporate time and result dependent future responses instead of relying on static user behavior, and it allows the user to incorporate a variety of tax modeling parameters, transaction modeling parameters, fee modeling parameters, and mortality models. In addition, the present invention is a significant improvement in that it provides a customizable framework for displaying obtained results and generating reports containing the obtained results.

### BACKGROUND

1. Field of Invention

The invention relates generally to the field of financial forecasting and financial advisory. More particularly, the invention relates to a system and method for providing investment advice regarding possible future financial outcomes.

2. Description of Related Art

Traditionally, financial forecasting for individuals relied on point estimates. These single point estimates were applied to the major variables involved, including the rate of return for invested assets, the rate of consumption, and the date of life expectancy. This prior art suffered from an inability to model a range of possible returns. The focus on single point estimates illustrated a possible average result without indicating the danger associated with unlikely, but still meaningful, adverse results. Given that this danger was exactly what was most important to individuals planning their financial future, this prior art was insufficient to provide comprehensive financial advice.

A second generation of forecasting models remedied this deficiency through the use of simulation methods. By conducting many individual estimates incorporating a probability distribution applied to a small number of model components, namely asset returns, consumer price index changes and client mortality, this prior art improved upon point estimates and replaced them with a range of possible outcomes. However, this prior art failed to incorporate numerous other factors relevant to forecasting financial outcomes. In this sense it suffered from the same deficiency as before—by holding static the vast majority of model inputs, this prior art failed to provide a robust and realistic picture of likely future outcomes, and therefore was itself insufficient to provide comprehensive financial advice. That this prior art was presented in an oversimplified way in order to be easy to use by lay users only compounded this deficiency.

The present invention overcomes these deficiencies in numerous areas. It allows the user to select from a range of possible asset return models, including models which incorporate a time varying return for assets which more accurately replicate historical asset returns than static distribution models. It allows the user to specify a range of inflow and outflow formulae which may themselves incorporate time varying parameters or be dependent on other variables within the model. It allows the user to select from an array of portfolio balancing and risk management techniques and to therefore incorporate time and result dependent future responses instead of relying on static user behavior. Finally, it allows the user to incorporate a variety of tax modeling parameters, transaction modeling parameters, fee modeling parameters, and mortality models.

An additional short coming of prior art is its inability to provide the user with a customizable framework for displaying obtained results. This prior art generated static output to display the results of its program. The user was not able, in this prior art, to enter text, to specify individual data series for display, to adjust graphical properties, and to create a custom report consisting of data, tables, graphs and texts selected and entered as specified by the user of the prior art. All of these deficiencies are remedied in the present invention.

### SUMMARY DESCRIPTION OF THE INVENTION

It is an object of the present invention to implement a program and system to determine and display a distribution of possible financial outcomes for a given initial portfolio allocation including owned annuities while allowing the user to, at their discretion, incorporate a set of auxiliary options including, by way of example, but not limited to, modeling of time varying return parameters for assets, defined or formula driven inflows or outflows over time, portfolio balancing and risk management options, taxation models, investment fee models, asset turnover models, and client mortality models.

A second object of the present invention is to implement a program and system to allow the user of a simulation to select specific output from a simulation, including but not limited to, data, tables and graphical output, to select a customized format for the specific output, to add customized text, to apply formats to the text, and to layout the data and the text according to their preference to form a customized report.

In embodiments of the present invention, the user, through the use of a web browser, accesses a website, provides a log in, enters information through a graphical user interface, and activates a simulation. The user may, at any time, choose to store the values entered within the interface to a database and to access those values at any future time. The program and system then executes the simulation, in which a number of simulated future evolutions of the initial specified conditions are calculated. Each simulated evolution is stored within the memory of the server. At the culmination of the simulation, these combined results and mathematical transformations of these results are stored within a database (and are available for future retrieval) and are displayed to the user in a series of graphs and tables. The user then selects from this available data, including but not limited to, data, tables and graphical output, customizes the format of the data, applies customized texts, formats the text, and creates a customized report by laying out the data and text according to their preference. The user may then perform additional operations upon this report, including but not limited to, saving the report to a database with the program and system for future retrieval, saving the report locally on their computer, or printing the report.

### BRIEF DESCRIPTION OF THE DRAWINGS

FIG. 1 shows and overview of key components, and the flow of information between key components and users, for an embodiment of the present invention.

FIG. 2 is a flow diagram which illustrates and example of how the user may interact with an embodiment of the present invention.

FIG. 3 is a flow diagram of the logic performed in completing a simulation in an embodiment of the present invention.

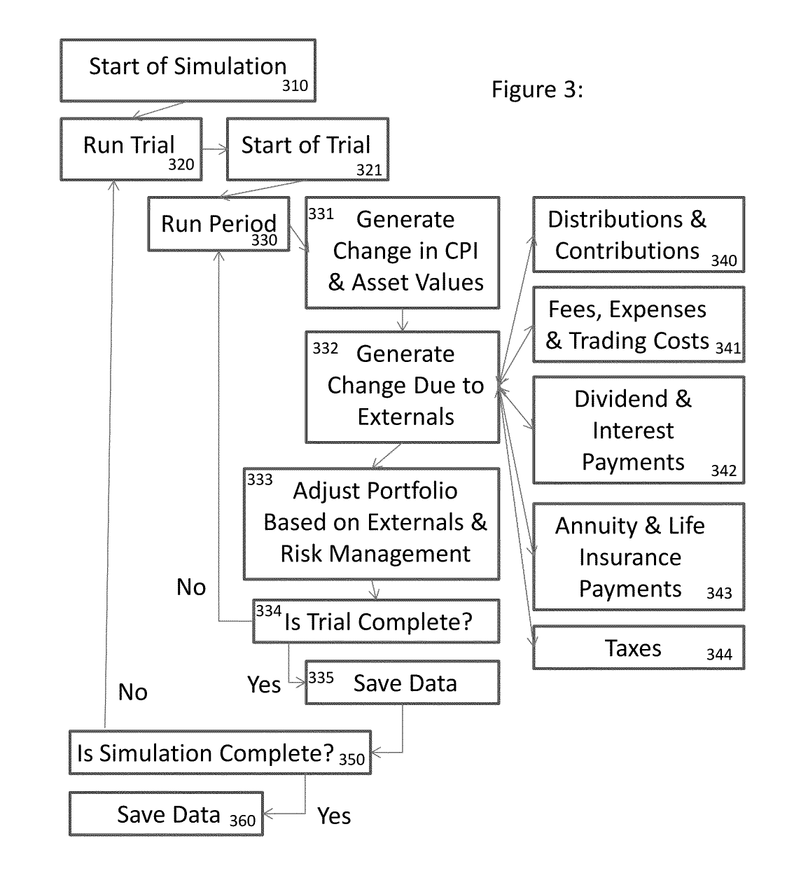

### DETAILED DESCRIPTION OF THE INVENTION

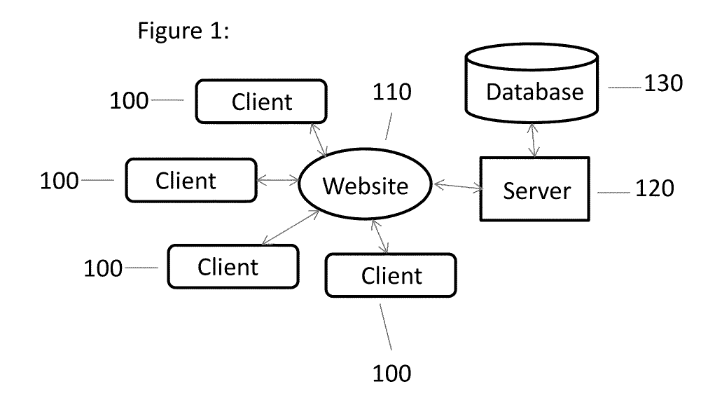

The preferred embodiments of the present invention will be described herein. These embodiments will reference the drawing of the program and system in FIG. 1.

In embodiments of the present invention, the system and program comprise both hardware and software elements. The hardware, as illustrated in FIG. 1, comprises a server 120, including one or more central processing units, internal memory devices and hard disk storage devices. The server is connected to a database 130 for permanent storage. Although there are many means by which a user may interact with a server, the preferred embodiment of the present invention is for the server to act as a webpage server. The user client 100, through the use of a browser on a personal computer or other web enabled device, accesses this website 110 and through this webpage accesses all aspects of the present invention.

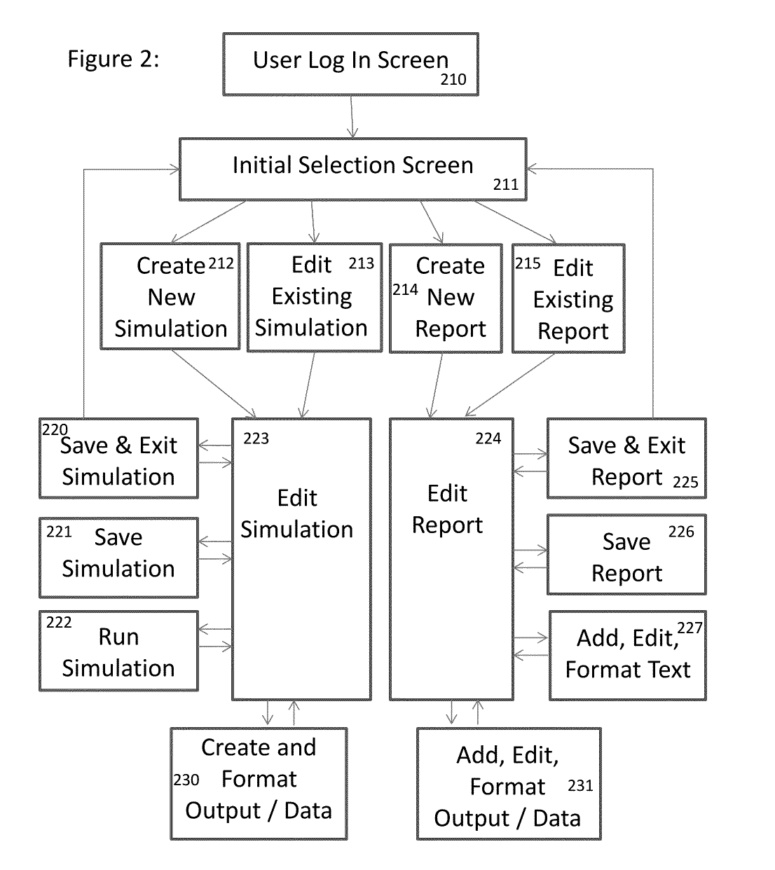

In embodiments of the present invention, the user, as illustrated in FIG. 2, upon first accessing the web page user log in screen 210 generated by the program and system provides log in information including, but not limited to, a user name and password. The program and system verifies the integrity of the user log in and retrieves information specific to the user, including, but not limited to, any simulations and reports the user has saved in the past. This is displayed in the initial selection screen 211.

In embodiments of the present invention, the program and system, after verifying the identity of the user, allows the user, as is further illustrated in FIG. 2, in addition to other possible actions, to either 1) create a new simulation 212, 2) retrieve an existing simulation that the user created and saved in the past 213, 3) create a new report 214, or 4) access an existing report that the user has created and saved in the past 215.

A simulation, in the context of the present invention, includes but is not limited to, information entered by the user in the graphical user interface provided by the program and system, and data, including but not limited to data, tables, and graphical content, generated by the program and system corresponding to the information entered by the user.

The data of a simulation is generated by calculating the evolution of a portfolio of assets and annuities subject to a variety of external factors over a sequence of intervals over a series of trials. Each trial begins with an initial starting state and then proceeds across a number of intervals determined by either a user specified end period or the death of all beneficiaries specified within the trial. The calculations within each interval include, but are not limited to, determining the current monthly return of each asset in a given portfolio, determining the current monthly payment from each annuity, determining the net change in the value of the current portfolio due to external factors, including but not limited to dividends or interest payments from assets within the portfolio, distributions removed from or contributions added to the portfolio, fees, expenses and trading costs to be paid by the portfolio, annuity and life insurance premiums to be paid by and life insurance distributions to be paid to the portfolio, and taxes due to be paid by or credited to the portfolio. The data of the simulation includes, but is not limited to, the data generated during each period as well as mathematical transformations of that data including summations, averages, and weighted averages. The data for all the trials within a simulation are saved separately and are used to generate aggregate data for the simulation as a whole.

A report, in the context of the present invention, includes but is not limited to, data, including but not limited to data, tables and graphical content generated by the program and system corresponding to the information entered by the user, customizations of the data, text entered by the user, customizations of text entered by the user, and the layout of the data and the text within a series of pages.

If the user chooses either to create a new simulation, then, in the context of the present embodiment of the invention, they do so through the edit simulation interface 223.

Features of a simulation which may be specified by a user include, but are not limited to, the initial asset mix, the presence, properties and attributes of annuities, the parameters used to determine changes in the consumer price index, the type of return generation model, the taxation settings, the risk management settings, including but not limited to the rebalancing setting and reserve fund settings, the number of trials and length of each trial, the random number seeds to specify the generation of random numbers throughout the simulation, the number, type and properties of distributions and contributions to be made during the simulation, the properties of beneficiaries of the simulation, the applicable investment fees and transaction cost settings, the risk metrics to be evaluated in the context of the simulation and the adjustments to be made to the data resulting from the simulation. Examples of these features and of how they may be selected are detailed in the following paragraphs.

The initial asset mix may be comprised of financial assets including, but not limited to, individual securities, funds, or other equity holdings, individual fixed income assets, funds, or other fixed income holdings, commodities holdings, real estate holdings, or other financial assets. The annuities may provide a fixed payout over the life of the annuity or they may increase or decrease based on a fixed or variable percentage at monthly intervals or based on the increase or decrease of specified assets or the increase or decrease of the consumer price index.

Each asset holding may have additional specified properties, including but not limited to, the number of significant holdings within the asset class, the annual dividend or interest payout, the taxable basis of the asset in question, the annual percentage turned over due to normal trading activity, and whether the asset is to be considered safe in the context of risk management operations. The user may also provide customized return and variance statistics for each asset in place of historically derived values. The parameters used to determine changes in the consumer price index may be based on historical data or specified by the user.

The return model selected by the user determines how the values of asset classes change over time. For every asset class, the model generates a monthly return factor. This return factor, when multiplied by the prior month value of the asset, determines the current month value of the asset. The monthly return factor is determined by using a random number to select from a distribution of possible return factor values. This distribution may be specified either using historical data or according to custom values specified by the user. The parameters used to select from the distribution may be specified by the user to be either static or dynamic over the life of the simulation. Static values provide for a constant distribution over time. Dynamic values allow the nature of the distribution to change over time and thereby model changing underlying market conditions over the life of the simulation. In the case of dynamic values, the user may select how the initial market state is to be determined.

The user may select the taxation model to determine how taxes are applied to investment gains and losses over the life of the simulation. The user may set the taxation rate to be applied to both ordinary and long term income as well as the aversion to realizing gains on specific assets. Aversion to taxation determines the degree to which sales made in assets realize the difference between the asset's basis and its current value.

The user may select from different risk management techniques, including rebalancing and the use of a reserve fund. Rebalancing involves increasing the value invested in certain assets while decreasing the value invested in other assets in order to more closely match a desired overall portfolio structure. The user may choose to activate rebalancing either according to a fixed calendar or when the allocation to any given assets differs from target by more than a threshold amount. The target allocation can either be static or can depend on a floor and multiplier model, in which the weighting within a portfolio between assets classified as risky versus assets classified as safe is based on the difference between the aggregate value of the assets within a portfolio and a floor value. The floor value may, according to the will of the user, be static or dynamic over the course of a trial. The use of a reserve fund involves maintaining a fund separate from the portfolio which can be used to supplement the portfolio in the case of excessive drawdowns.

The user may fix seeds for random numbers generated during the simulation. In the absence of user generated seeds, the random numbers generated by the simulation will differ each time the simulation is run. For any specified value of seed, the random numbers generated will follow the same sequence.

The user may specify both one time and recurrent distributions and contributions to take place during the simulation. One time distributions and contributions are specified by a time during the simulation at which point the adjustment takes place and a dollar amount that is either added to or removed from the portfolio. Recurring contributions and distributions are activate over a specified time period and may either be an absolute amount, which can grow or shrink during the course of the simulation, or a percentage of the current portfolio value.

The user may specify any number of beneficiaries of the portfolio. For each beneficiary, the user may specify gender, age, health, and the existence of any associated life insurance policies and their respective terms, benefits, and premiums. The survival of the beneficiaries is tracked as an element of the data saved for a given simulation.

The user may specify the application of investment fees, specified as a percentage fee to be applied to a given aggregate value of assets or as a series of percentage fees to be applied to a series of ranges of aggregate value of assets. The user may specify the application of transaction costs and the severity of these costs. The user may specify the parameters of risk metrics to be tracked during the simulation, including the likelihood of bankruptcy, the likelihood of the aggregate portfolio value falling below a specified dollar amount or declining more than a specified amount over a specified time interval, and the likelihood of distributions falling below an aggregate dollar amount during any interval.

At any time during the specification of a simulation, the user may, in the preferred embodiment of the invention, save their work in the current simulation and then either continue work on the existing simulation 221 or save their work and return to the initial selection screen 220, or to run the simulation as currently specified 222.

Running the simulation begins in start of simulation 310. The program and system then generates the specified number of possible trials 320 of the current simulation.

A trial, in the context of the present invention, consists of a series of periods 330. In each period, the system and program calculates, according to the values specified by the user, the period change in the consumer price index and the period return for each asset 331. The system and program then calculates the net dollar change to the portfolio during the period due to external events 332, including, but not limited to, contributions and distributions 340, dividend and interest payments 342, annuity payments and life insurance premiums and payments 343, tax payments and credits 344, and investment fees and transaction fees 341. The system and program then calculates, consistent with the selected risk management options and the net dollar change due to external events, the resulting dollar values of the holdings within the portfolio 333. The system and program repeats this period calculation until either the specified number of periods has elapsed or all of the initial beneficiaries have been determined to no longer be alive 334.

During the execution of the trial, the system and program saves data pertaining to each period within the trial. At the culmination of the trial, the system and program saves data pertaining to the trial itself 335. At the culmination of all the trials 350, the system and program generate a series of data, tables and graphs using the data saved during the simulation 360. The user may, in the preferred embodiment of the invention, create new tables and graphs and select which aspects of the data to appear within the tables and graphs 230. The user may format all aspects of the data, including but not limited to changing font, size, color, and location of text, color, type and format of table, and color type and format of graph.

Once at least one simulation has been completed, the user may, in the preferred embodiment of the system, as further illustrated in FIG. 2, create a new report 214. Existing reports can also be edited 215 to incorporate the results of new simulations. Editing a report, in the current embodiment of the system, includes adding text to a report 227, or editing, formatting and adding output data or graphics to a report 231. A report consists of a sequence blocks. Each block will be of a specific type, including, but not limited to, textual blocks and data blocks. The user may, at any time, save a report and continuing editing 226 or save a report and exit 225 to the initial selection screen 211.

A textual block consists of user entered text. The user may perform a number of operations on this text, including but not limited to adding or removing text and changing the size, type, color and style of text. The text editing and formatting functionality is well known as word processing.

A data block consists of data, tables, graphical elements or other information derived directly from a previously run simulation. The data, tables and graphical elements may also be edited and modified, including but not limited to changing the font, size, text, color, shape, and shading. The data may be drawn from a single simulation or from multiple simulations.

The user may perform operations on the sequence of blocks including, but not limited to, the following. The user may insert a block into any position within the sequence blocks. The user may also change the order of existing blocks by moving a selected block either up or down within the sequence. The user may also delete a selected block from the report.

In the foregoing specification, the invention has been described as applies to a specific embodiment. It will, however, be evident that modifications and changes may be made to the embodiment without departing from the broader scope of the invention.

1) A computerized system and method for determining and displaying possible future financial outcomes for a given initial portfolio allocation of financial assets which may include owned annuities while allowing the user to, at their discretion, incorporate a set of auxiliary options including, by way of example, but not limited to, modeling of time varying return parameters for assets, defined or formula driven inflows or outflows over time, portfolio balancing and risk management options, taxation models, investment fee models, asset turnover models, and client mortality models.

2) A computerized system and method for allowing a user to create customized reports by selectively incorporating the results of a simulation program, including the data, tables, graphs, and other output, and adding text, formatting, graphics, and other information at their discretion, in order to thereby create a customized document illustrating the results of a simulation.

3) A computer system comprising a processor to execute logic routines, a storage device coupled to said processor to record data for future retrieval, and a server to make the system available to users, and a machine readable medium having stored therein said routines and data necessary to said routines.
